(19) United States
(12) Patent Application Publication
(10) Pub. No.: US 2019/0001383 A1
(43) Pub. Date: Jan. 3, 2019

(54) ROLLING STAND FOR THE ROLLING OF ROLLING STOCK

(71) Applicant: SMS Group GmbH, Duesseldorf (DE)

(72) Inventors: Daniel Knie, Freudenberg (DE); Johannes Alken, Siegen (DE)

(21) Appl. No.: 15/748,676

(22) PCT Filed: Jul. 27, 2016
(86) PCT No.: PCT/EP2016/067906

§ 371 Date: Jan. 30, 2018

(30) Foreign Application Priority Data
Jul. 31, 2015 (DE) 102015214642.1
Oct. 13, 2015 (DE) 102015219864.2
Nov. 30, 2015 (DE) 102015223676.5

(51) Int. Cl. B21B 31/07; F16C 32/06

(52) U.S. Cl. CPC B21B 31/074; B21B 31/076; F16C 2322/12; B21B 2203/24; B21B 2203/26; F16C 32/0629

(57) ABSTRACT

The invention relates to a rolling stand and a rolling mill for the rolling of preferably metallic rolling stock. Known rolling stands of this type typically have two back-up rolls (110) which are rotatably mounted by way of their roll journals in chocks which function as oil film bearings. The oil film bearings are supplied with coolant and/or lubricant by means of a low-pressure circuit which has at least one low-pressure pump (130) for conveying the coolant and/or lubricant. To reduce the costs for driving the low-pressure pump (130), there is provided according to the invention a gear mechanism which is arranged on the roll face-remote side of at least one of the chocks in order to rotationally couple the at least one low-pressure pump (130) to the back-up roll journal (120) which is rotatably mounted in the chock.

The invention relates to a rolling stand for the rolling of preferably metallic rolling stock. Moreover, the invention relates to a rolling mill with a plurality of rolling stands.

Such rolling stands are basically known in the prior art, e.g., from WO 2013/048836 A1. The rolling stand disclosed in it for rolling metallic rolling stock discloses a roll with two roll journals rotatably supported in a chock, also called a support housing. The support of the roll journals in highly loaded stands takes place here in a cylindrical receiving space in the chock. The known rolling stand is connected to a low-pressure circuit for the coolant and/or lubricant.

The low-pressure circuit for the coolant and/or lubricant comprises a low-pressure pump and a tank for the coolant or lubricant which are both typically arranged remotely from the rolling stand, e.g., in the base of a rolling mill. Low-pressure lines, which are typically run along the frame windows of the rolling stand, connect the low-pressure pump to the low-pressure inlets in the receiving space of the chock for the roll journals, wherein these low-pressure inlets are typically distributed at 90° or 270° positions relative to the loading zone on the circumference of the receiving space. The supplying of the receiving space and/or the annular slot between the chock and the roll journal supported in it with coolant and/or lubricant at a low pressure, i.e., for example, 2 bar, is as a rule sufficient for a hydrodynamic lubrication.

However, the arrangement of the low-pressure pump remotely from the rolling stand known from the cited international application WO 2013/048836 A1 is not appropriate for various reasons:

On the one hand, the necessary low-pressure lines for connecting the low-pressure pump to the low-pressure conduits in the chock are relatively long. Furthermore, the low-pressure pump requires its own external drive.

The invention has the basic object of further developing a known rolling stand in the known rolling mill for rolling rolling stock in such a manner that the expenses for the drive of the at least one low-pressure pump can be reduced.

This problem is solved by the subject matter of claim 1. This claim is characterized in that a gear mechanism is provided which is arranged on a side of at least one of the chocks remote from the roll face for the rotary coupling of the at least one low-pressure pump to the back-up roll journal rotatably supported in the receiving space.

The claimed gear mechanism has the advantage that the low-pressure pump is driven by the roll journal when the latter rotates. Therefore, a separate drive, typically an electromotor for the low-pressure pump, is not necessary; the expenses for it and the expenses for electronic or hydraulic supply lines for the drive can be saved.

The present invention and in particular the claims apply to four-high rolling stands with two work rolls and two support rolls and to six-high rolling stands with two work rolls, two intermediate rolls and two support rolls. However, the present invention also applies to two-high rolling stands with only two work rollers which set a roll slot. For this case the concept “back-up roll” in the claims and in the specification is to be understood as a work roll.

The invention refers expressly only to low-pressure pumps for typically less than 100 bar in a low-pressure circuit for coolant and/or lubricant on a rolling stand. Any possible additional high-pressure circuit present on a rolling stand with a high-pressure pump for pressures of 500 to 2,000 bar is expressly not subject matter of the present invention, especially not of the present claims.

According to a first exemplary embodiment, the gear mechanism is designed as a gear transmission with a pinion and a drive gear which are directly or indirectly rotationally coupled to one another. The pinion is set in a non-rotating manner on the drive shaft of the low-pressure pump or the free end of the drive shaft is designed itself as pinion. According to a first variant of the gear mechanism the drive gear is designed as a gear ring with toothing on the outside and which is preferably connected on the roll face-remote side in a non-rotating manner to the roll journal or to a journal bush set on the roll journal in a non-rotating manner. The low-pressure pump is then arranged in such a manner that the pinion of its drive shaft is in engagement with the gear ring toothed on the outside preferably directly, i.e., without the interposition of other gears. If a certain transmission is required, other gears can of course be connected therebetween. In particular in the case of the cited first variant of the gear mechanism the low-pressure pump can advantageously be built in a space-saving manner into a recess of the chock.

A second variant of the gear mechanism provides that the drive gear is designed as a gear ring with toothing on the inside and which is connected on the roll face-remote front side of the roll journal in a nonrotating manner and is preferably coaxially connected to the latter. The low-pressure pump is then arranged in front in such a manner on the front side of the roll journal in the axial direction that the pinion of the drive shaft of the low-pressure pump is preferably directly engaged with the gear ring with the toothing on the inside.

The expression that the pinion is directly engaged with the drive gear means that the pinion teeth engage into the toothing of the drive gear. In contrast to the above, an indirect engagement means that the pinion and the drive gear are rotationally connected to one another by a chain or with the interposition of other gears or in some other manner.

If a support bush is provided in the chock as a wear part for setting the receiving space, the low-pressure input and output conduits for the coolant and/or lubricant open on the inside of the support bush into the receiving space. The conduits are constructed in the chock as conduits and have a fluid-conducting connection with the low-pressure lines outside of the chock.

According to another exemplary embodiment, the chocks, also called oil film bearings, can be operated quasi free of oil loss, that is, they are constructed tightly, and the rolling stand is individually associated with a tank or the rolling stand is preferably individually associated with two tanks for its four oil film bearings for its two back-up rollers. The improved sealing technology advantageously allows for the first time to reduce the amount of oil necessary on the whole for a rolling stand, in comparison to the prior art.

The concept “quasi free of oil loss” means in the sense of the invention that the oil losses per an oil film bearing are less than 0.1 l/h, preferably even less than 0.01 l/h.

The amount of oil to be stored in in the case of the oil film bearings with the improved sealing technology is only at 50% or less in comparison to the amount of oil traditionally to be stored per rolling stand or per rolling mill. Due to the reduced amount, comparatively small tanks can be provided per rolling stand or per rolling mill. The entire holding volume of all tanks per rolling stand is, for example, between 1 and 8 m³. On account of the clearly lesser amount of oil to be stored, it is also financially worthwhile to fall back on synthetic oils and/or additives which not only have better qualities regarding demulsifying, oil foam formation, etc. but would also be advantageous for the functioning of the oil film bearings. The using of the claimed, decentralized tanks per rolling stand and/or per oil film bearing also advantageously reduces the expenses for the foundation works on account of a smaller or no longer necessary oil base as well as the expenses for the central oil piping.

Different exemplary embodiments for the arrangement of the at least two tanks on a rolling stand are described in the dependent claims. In particular, at least one of the tanks can be constructed integrated in a support housing, also called a chock, of the oil film bearing. In this manner the oil can be stored in the support housing.

The above-cited problem is furthermore solved for a rolling mill of claim 15. Accordingly, at least one of the rolling stands is constructed according to one of the previous claims.

The advantages of this claimed design for the rolling stands of a rolling mill correspond to the advantages cited above for an individual rolling stand. In particular, the central oil supply for all rolling stands of the rolling mill in the base can be eliminated with the associated cost savings.

According to an exemplary embodiment for the rolling mill, the tanks of the front rolling stands of the rolling mill are filled, to the extent that the carrying load of the rolling stands has reached a given threshold value for the carrying load, with a first type of oil which is especially designed for carrying loads up to the threshold value of the carrying load. Then the tanks of the rear rolling stands of the rolling mill are filled, to the extent that the carrying load of these roller stands drops below the given threshold value for the carrying load, with a second oil type which is specially designed for the speeds of the back-up rolls in the rear roller stands. The provision of different oil types and the associated advantages for the operation of the particular rolling stands were not possible at all until the claimed decentralization of the oil supply for the individual oil film bearings.

Finally, the claimed, decentralized oil supply of the individual stands has the advantage that the size and the volumes of the tanks can be individually coordinated with the particular oil requirement of the individual stands. This can be significant especially in a rolling mill, where less oil must be stored for the relatively slow-running front rolling stands than for the more rapidly running rear roll stands. Each tank and each oil circuit can be associated with its own filter device for the oil and/or with a cooling device for the oil.

Seven figures are attached to the specification, in which:

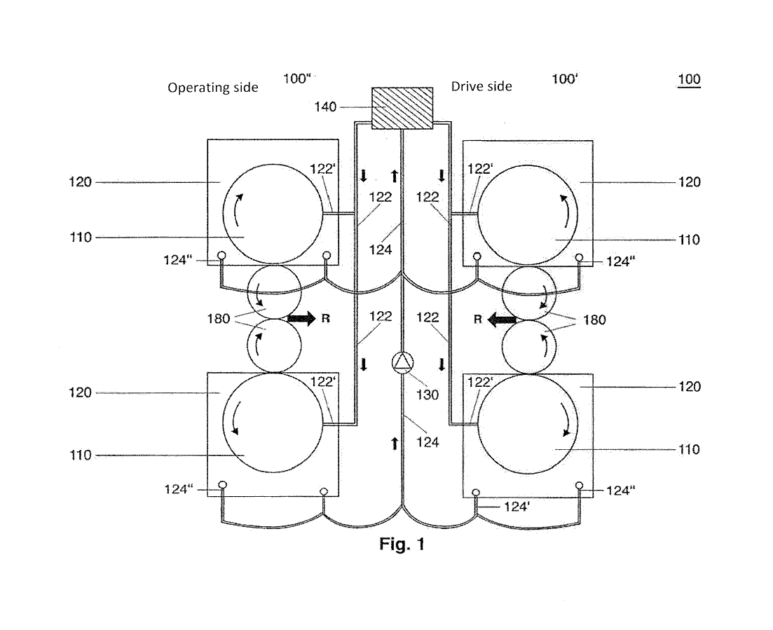

FIG. 1 shows a first exemplary embodiment for the association of a tank with the oil film bearings of a rolling stand;

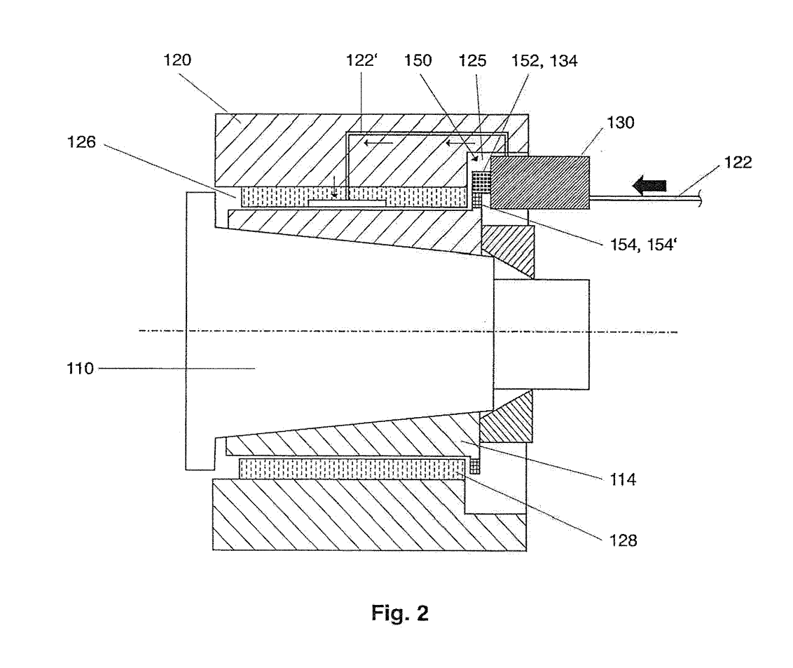

FIG. 2 shows a longitudinal cross-cross-section through a chock with a roll bearing supported in it with a first variant of the gear mechanism for driving the low-pressure pump in a first installed position;

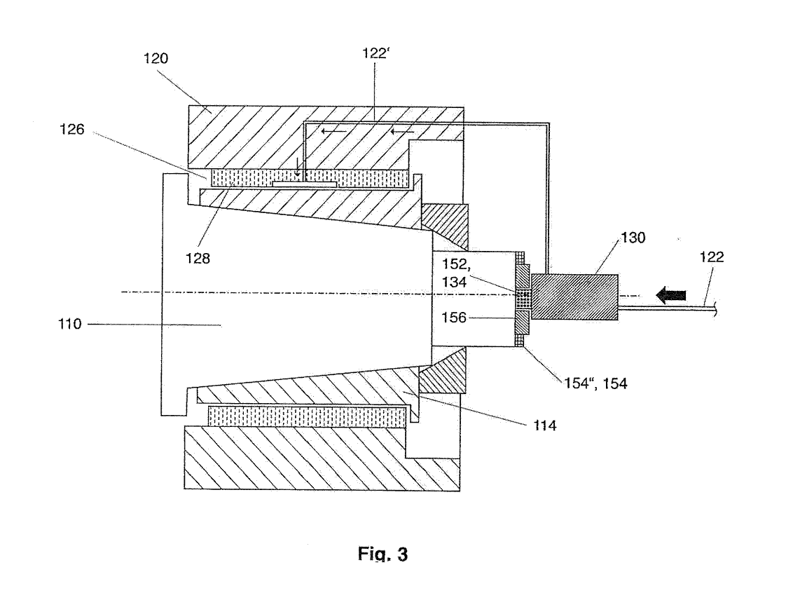

FIG. 3 shows a longitudinal cross-cross-section through the chock with a roll bearing supported in it with a second variant of the gear mechanism for driving the low-pressure pump in a second installed position;

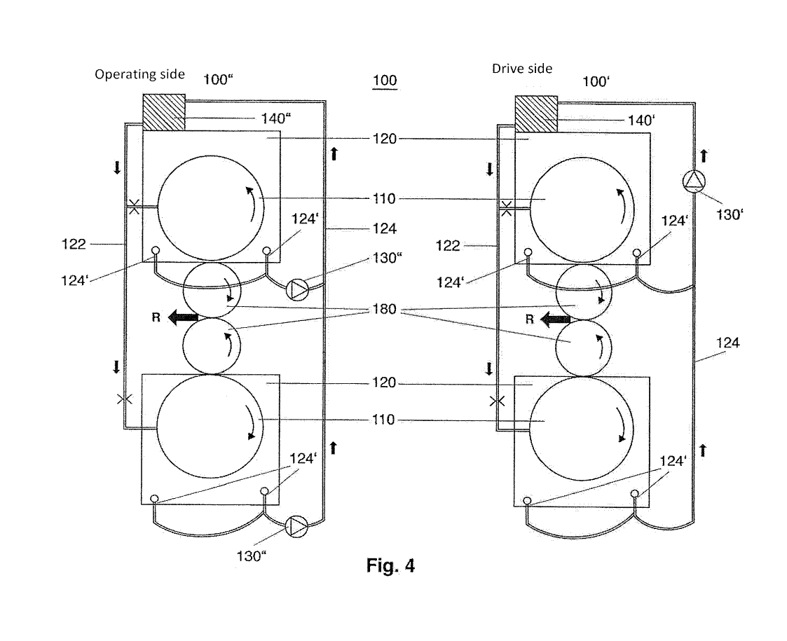

FIG. 4 shows a second exemplary embodiment for the association of the tanks with the oil film bearings of the rolling stand;

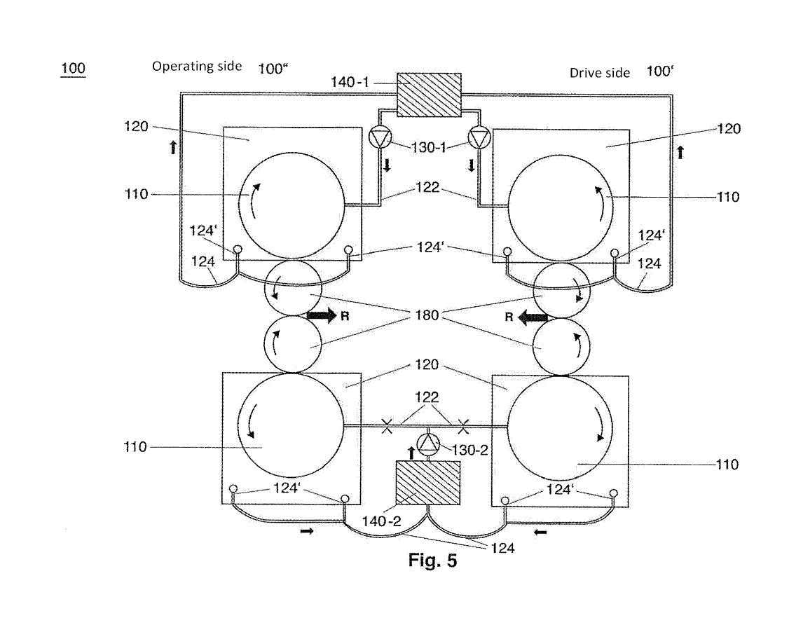

FIG. 5 shows a third exemplary embodiment for the association of the tanks with the oil film bearings of the rolling stand;

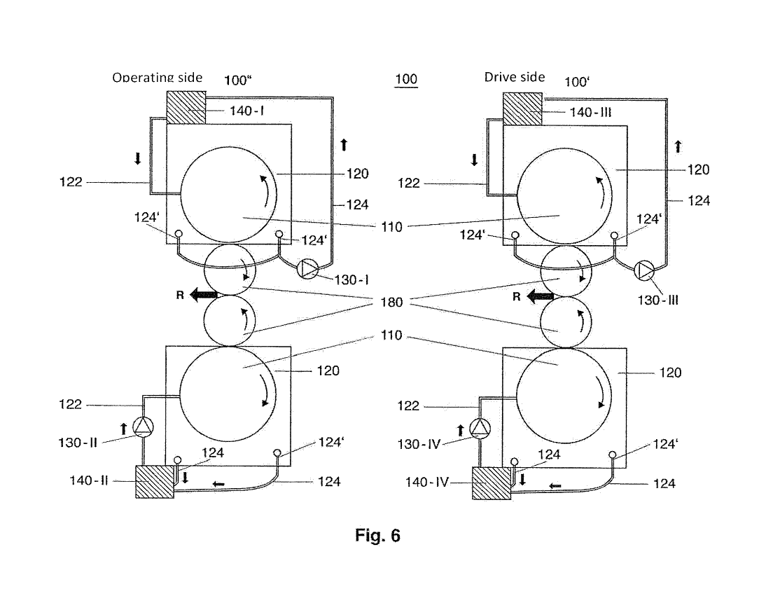

FIG. 6 shows a fourth exemplary embodiment for the association of the tanks with the oil film bearings of a rolling stand; and

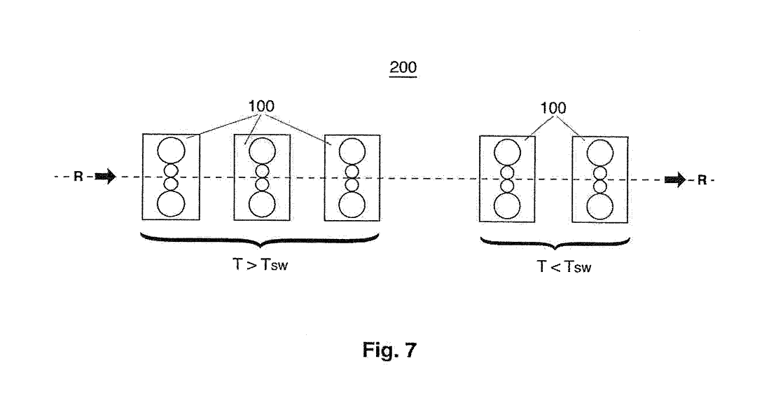

FIG. 7 shows a rolling mill with a plurality of rolling stands.

The invention is described in detail below with reference to the cited figures in the form of exemplary embodiments. In all figures, the same technical elements are designated with the same reference numerals. The reference numeral 140 also represents all variants of the reference numeral, i.e. 140′, 140″, 140-1, 140-2, 140-I, 140-II, 140-III and 140-IV. The reference numeral 130 is treated analogously.

All FIGS. 1 and 4 to 7 show by way of example four-high rolling stands 100 each with a roll frame 100′ on the drive side and a roll frame 100″ on the operating side. Each rolling stand comprises two back-up rolls which are rotatably mounted with their four roll journals 110 in oil film bearings 120. Each oil film bearing 120 comprises low-pressure supply lines 122 and low-pressure discharge lines 124. The return flows are returned into the tank or the tanks 140; the inflows are fed from the particular tank. The two middle rolls are work rolls 180 which typically set a roll slot between which rolling stock is transported in the rolling direction R and is rolled. The two work rolls 180 are supported by an upper and a lower back-up roll.

According to FIGS. 2 and 3 the chocks 120, also called support housings, comprise a cylindrical, possibly also conical receiving space 126 in which the particular roll journals 110 of the back-up rolls are rotatably supported. The receiving space 126 can optionally be set by a bearing bush 128 which is arranged in the chock in a non-rotating manner. An annular slot is formed between the chock 120 or the bearing bush 128 and between the roll journal 110 or a journal bush 114 optionally placed on the roll journal, which slot is filled during the operation of the rolling stand with coolant and/or lubricant. In order to supply the annular slot with the coolant and/or lubricant, inlets and outlets for the coolant and/or lubricant are provided on the periphery of the receiving space 126 which represent on the receiving-space side the ends of the low-pressure inlet conduit and of the low-pressure outlet conduit. The low-pressure inlet conduit 122′ typically enters into the receiving space in the region of a 90°- or 270°-position relative to the loading zone.

According to FIG. 1, a low-pressure circuit is associated with the rolling stand 100 in order to supply these low-pressure inlet conduits 122′ in the chocks with the coolant and/or lubricant. The coolant and/or lubricant run preferably geodetically out of a tank 140 via at least one low-pressure inlet line 122 of the low-pressure circuit into the low-pressure inlet conduits 122 in the interior of the chocks. Low-pressure outlet conduits 124′ can also be recognized in the chocks 120 adjacent to the low-pressure inlet channels 122′ which outlet conduits are connected for their part by lines to the low-pressure outlet lines 124 running back into the tank. The low-pressure circuit comprises at least one low-pressure pump 130 for pumping the coolant and/or lubricant back at a low pressure, for example, 1 to 10 bar, preferably 2 bar, into the tank 140.

FIG. 2 shows a longitudinal cross-section through a chock 120 with a roll journal 110 of a back-up roll supported in it with a first variant of the gear mechanism according to the invention between the low-pressure pump and the roll journal. It can be concretely recognized that the low-pressure pump 130 is constructed in a recess 125 of the chock 120 in such a manner that its drive shaft 134 is aligned preferably parallel to the longitudinal axis of the back-up roll. The outwardly projecting, free end of the drive shaft 134 is preferably designed for its part as a gear or as a pinion or it is a pinion 152 mounted on this drive shaft in a non-rotating manner. In the first variant of the gear mechanism shown in FIG. 2, the pinion 152 or the gear on the drive shaft-side directly engages with an outside-toothing of gear ring 154′ of a drive gear 154 which is mounted in a non-rotating manner coaxially on the roll face-remote side on the roll journal or on a journal bush 114 set on the roll journal. The gear mechanism 140 therefore consists in the present case of the pinion 152 and the drive gear 154 with gear ring 154′ toothed on the outside which are in direct engagement with one another. Alternatively, the gear mechanism 150 could also provide an indirect coupling of pinion and drive gear, e.g., via a chain or other, intermediately connected gear mechanism gears. The shown inclusion of the low-pressure pump 130 in the recess 125 of the chock 120 represents a very compact construction, which is very advantageous for the basically always quite constricted spatial conditions in the surrounding area of rolling stands.

It can furthermore be recognized in FIG. 2 that the low-pressure pump 130 is connected on the input side to the low-pressure supply line 122. On the output side the low-pressure pump 130 pumps the coolant and/or lubricant via the low-pressure supply conduits 122′ into the annular slot between the bearing bush 128 and the journal bush 114. The low-pressure supply conduits 122′ are largely provided in the interior of the chock 120.

FIG. 3 shows a longitudinal cross-section through the chock 120 with the roll journal of the back-up roll supported in it. In distinction to FIG. 2, the low-pressure pump 130 is arranged here on the roll face-remote front side of the roll journal 110. The pinion 152 of the driving shaft 134 of the low-pressure pump is coupled here in a rotational manner to the roll journal 110, for example, via intermediate gears 156 with the drive gear 154 with the gear ring 154″ toothed on the inside. The drive gear is preferably concentrically mounted in a non-rotating manner on the front side of the roll journal 110.

FIG. 4 shows another exemplary embodiment for the tank arrangement on or on top of the rolling stand 100. In concrete terms, according to this exemplary embodiment, a first common tank 140′ is provided for the two oil film bearings 120 of the upper and of the lower back-up roll on the roll frame on the drive side 100′. Furthermore, a second common tank 140″ for the oil film bearing 120 of the upper and lower back-up roll is provided on the roll frame on the operating side 100″ of the rolling stand 100. The first tank 140′ is preferably arranged on top on the roll frame on the drive side 100′, whereas the second comment tank 140″ is arranged on top on the roll frame on the operating side 100′.

According to FIG. 5, in another exemplary embodiment, a first common tank 140-1 is provided for the two oil film bearings 120 of the upper back-up roll on the drive side and the operating side of the rolling stand. Furthermore, a second common tank 140-2 is provided for the two oil film bearings 120 of the lower back-up roll on the drive side and the operating side. The first common tank 140-1 is preferably on top on the roll frame 100′ on the drive side or on top on the roll frame 100″ on the operating side of the rolling stand. The same preferably also applies to the second common tank 140-2.

FIG. 6 illustrates a third exemplary embodiment of the present invention, according to which the four oil film bearings 120 for the two back-up rolls are each individually associated with its own tank 140-I, 140-II, 140-III and 140-IV.

FIG. 7 shows a typical rolling mill for the hot and/or cold rolling of metallic rolling stock. It consists substantially of a plurality of rolling stands 100 set up sequentially in a line. According to the invention at least one of the rolling stands 100, but preferably all rolling stands, are constructed according to one of the previously described exemplary embodiments for a single rolling stand.

Care is to be taken in the arrangement of the rolling stands in a rolling mill that the front, i.e., the rolling stands located upstream in the direction of rolling typically apply a greater rolling force than the rear ones, i.e., the rolling stands located downstream. Therefore, the front rolling stands are typically designed for high carrying loads (T) to T=T_{SW} with T_{SW}: carrying load threshold value. In contrast thereto, the rear rolling stands are typically designed only for carrying loads with T<T_{SW}; however, at the same time the rear rolling stands are designed for greater speeds. Based on these different operating conditions, the using of different oil types is recommended for the front and the rear rolling stands in the rolling mill. The using of different oil types was not possible at all until by the providing of individual tanks per rolling stand according to the invention.

These different operating conditions furthermore have the result that less oil must be stored for the front rolling stands than for the rear rolling stands; accordingly, the tank volume per rolling stand to be provided for the front rolling stands can be selected to be distinctly smaller than for the rapidly rotating rear rolling stands.

In concrete terms, it is provided that that the oil volume per rolling stand to be reserved in the decentralized oil supply according to the invention is reduced to one half compared to the traditional central oil supply. Therefore, the tank volume per stand to be reserved in the present invention is only 1-8 m³, i.e. in the case of 4 oil film bearings for rolling stand an amount of only 0.25-2 m³ per oil film bearing. The described fact that the front stands of the rolling mill only require a tank volume in the lower indicated range and only the rear rolling stands require a greater tank volume, results in an average value for the tank volume which corresponds according to the invention to less than 50% of the tank volume traditionally centrally reserved for a rolling mill.

In all exemplary embodiments the at least one low-pressure pump 130 can be built into the low-pressure supply line and/or in to the low-pressure discharge line as well as inside or outside of the chocks.

### LIST OF REFERENCE NUMERALS

100 rolling stand

100′ drive side

100″ operating side

110 back-up roll journal

114 journal bush

120 chock

122 low-pressure supply line

122′ low-pressure supply conduit

124 low-pressure discharge line

124′ low-pressure discharge conduit

125 recess in the chock

126 receiving space or annular slot

128 bearing bush

130 low-pressure pump

130′, 130″ low-pressure pump

130-1, 130-2 low-pressure pump

130-I . . . 130 IV low-pressure pump

134 drive shaft of the low-pressure pump

140 tank

140′, 140″ tank

140-1, 140-2 tank

140-I . . . 140 IV tank

150 gear mechanism

152 pinion

154 drive gear

154′ gear ring with external toothing

154″ gear ring with internal toothing

156 intermediate gears

180 work rolls

200 rolling mill

R rolling direction

T carrying force

T_{SW} carrying force threshold value

1. A rolling stand (100) for rolling preferably metallic rolling stock comprising two back-up rolls each with two back-up roll journals (110), four chocks (120) in the form of oil film bearings, each with a cylindrical receiving space for the rotatable support of one of the back-up roll journals (110), wherein the chocks comprise in their interior at least one low-pressure supply conduit (122′) for supplying coolant and/or lubricant into the receiving space and comprise at least one low-pressure discharge conduit (124′) for removing the coolant and/or lubricant out of the receiving space, and at least one low-pressure circuit with a low-pressure supply lines (122) for connecting a tank (140) for the coolant and/or lubricant to the low-pressure supply conduit (122′) of the chock, with low-pressure discharge lines (124) for connecting the low-pressure discharge conduit to the tank, and with at least one low-pressure pump (130) for delivering the coolant and/or lubricant into the low-pressure circuit,
characterized in that
a gear mechanism (150) is provided which is arranged on the roll face-remote side of at least one of the chocks for the rotational coupling of the at least one low-pressure pump (130) to the back-up roll journal (110) rotatably supported in the receiving space.

2. The rolling stand (100) according to claim 1,
characterized in that
the gear mechanism (150) is constructed as a gear mechanism with a pinion (152) and a drive gear (154) which are directly or indirectly coupled to one another in a rotational manner, and
that the pinion (152) is placed in a non-rotating manner on the drive shaft (134) of the low-pressure pump (130) or that the free end of the drive shaft is constructed as the pinion (152).

3. The rolling stand (100) according to claim 2,
characterized in that
the drive gear (154) is designed as a gear ring (154′) with toothing on the outside and which is preferably connected on the roll face-remote side in a non-rotating manner to the back-up roll journal (110) or to a journal bush (114) set in a non-rotating manner on the back-up roll journal, and that the low-pressure pump (130) is arranged in such a manner that that the pinion (152) of its drive shaft (134) engages preferably directly with the gear ring (154′) with toothing on the outside.

4. The rolling stand (100) according to claim 2,
characterized in that
the drive gear (154) is designed as a gear ring (154′) with toothing on the inside and which is preferably connected on the roll face-remote side in a non-rotating manner to the back-up roll journal (110) wherein the low-pressure pump (130) is arranged in such a manner in front that that the pinion (152) of its drive shaft (134) engages preferably directly with the gear ring (154′) with toothing on the inside.

5. The rolling stand (100) according to claim 1,
characterized in that
the low-pressure pump (130) is integrated into the chock (120), for example, is built into a recess of the chock.

6. The rolling stand (100) according to claim 1,
characterized in that
the at least one chock (120) comprises a bearing bush (128) arranged in a non-rotating manner which sets the receiving space, wherein an at least one low-pressure supply conduit and one low-pressure discharge conduit (122′, 124′) for the coolant and/or lubricant in the chock penetrate the bearing bush.

7. The rolling stand (100) according to claim 1,
characterized in that
two work rolls (180) are provided which are arranged between the two back-up rolls and which set a roll slot for rolling the rolling stock.

8. The rolling stand (100) according to claim 1,
characterized in that
the at least one low-pressure pump (130) is built into the low-pressure supply lines (122) and/or into the low-pressure discharge lines (124) of the low-pressure circuit.

9. The rolling stand (100) according to claim 1,
characterized in that
the oil film bearing is designed to be operated quasi without loss of oil and that at least two tanks (140′, 140″) with at least two associated low-pressure circuits for the four oil film bearings are individually associated with the rolling stand (100).

10. The rolling stand (100) according to claim 9,
characterized in that
a first common low-pressure circuit with a first low-pressure pump (130′) and a first common tank (140′) for the two oil film bearings of the upper and of the lower back-up roll is provided on the roll frame on the drive side (100′), and that a second common low-pressure circuit with a second low-pressure pump (130″) and a second common tank (140″) for the oil film bearing of the upper and of the lower back-up roll is provided on the roll frame on the operating side (100′).

11. The rolling stand (100) according to claim 10,
characterized in that
the first tank (140′) is arranged on top on the roll frame on the drive side (100′) and/or that the second tank (140″) is arranged on top on the roll frame on the operating side (100″).

12. The rolling stand (100) according to claim 9,
characterized in that
a first common low-pressure circuit with at least one first low-pressure pump (130-1) and with a first common tank (140-1) for the two oil film bearings of the upper back-up roll is provided on the drive side (100′) and on the operating side (100″), and that a second common low-pressure circuit with a second low-pressure pump (130-2) and with a second common tank (140-2) for the two oil film bearings of the lower back-up roll is provided on the drive side (100′) and on the operating side (100″).

13. The rolling stand (100) according to claim 12,
characterized in that
the first common tank (140-1) is arranged on top on the roll frame on the drive side (100′) or on top on the roll frame on the operating side (100″).

14. The rolling stand (100) according to claim 9,
characterized in that
each of the four oil film bearings (120) for the two back-up rolls is individually associated with its own low-pressure circuit with its own low-pressure pump (130-I, 130-II, 130-III and 130-IV) and its own tank (140-I, 140-II, 140-III and 140-IV).

15. A rolling mill (200) with a plurality of rolling stands (100) arranged sequentially in a line for rolling metallic rolling stock,
characterized in that
at least one of the rolling stands (100) comprises two back-up rolls each with two back-up roll journals (110), four chocks (120) in the form of oil film bearings, each with a cylindrical receiving space for the rotatable support of one of the back-up roll journals (110), wherein the chocks comprise in their interior at least one low-pressure supply conduit (122′) for supplying coolant and/or lubricant into the receiving space and comprise at least one low-pressure discharge conduit (124′) for removing the coolant and/or lubricant out of the receiving space, and at least one low-pressure circuit with a low-pressure supply lines (122) for connecting a tank (140) for the coolant and/or lubricant to the low-pressure supply conduit (122′) of the chock, with low-pressure discharge lines (124) for connecting the low-pressure discharge conduit to the tank, and with at least one low-pressure pump (130) for delivering the coolant and/or lubricant into the low-pressure circuit,
characterized in that
a gear mechanism (150) is provided which is arranged on the roll face-remote side of at least one of the chocks for the rotational coupling of the at least one low-pressure pump (130) to the back-up roll journal (110) rotatably supported in the receiving space.

16. The rolling mill (200) according to claim 15,
characterized in that
the tanks (140) of the front rolling stands of the rolling mill (200) are filled with a first oil type, and that the tanks (140) of the rear rolling stands are filled with a second oil type.
